(19) United States
(12) Patent Application Publication
(10) Pub. No.: US 2010/0303424 A1
(43) Pub. Date: Dec. 2, 2010

(54) OPTICAL WIRING CABLE

(75) Inventor: Hideto Furuyama, Yokohama-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/756,515

(22) Filed: Apr. 8, 2010

(30) Foreign Application Priority Data
May 28, 2009 (JP) 2009-129264

(51) Int. Cl. G02B 6/36

(52) U.S. Cl. 385/92

(57) ABSTRACT

An optical wiring cable that transmits a light signal includes a first connector including a light transmission portion, a second connector including a light reception portion, and an optical wire provided between the first and second connectors to optically couple the light transmission portion and light reception portion. Further, a heat release wire is provided along the optical wire and thermally coupled with the light transmission portion and light reception portion to release heat generated from the light transmission portion and light reception portion.

### CROSS-REFERENCE TO RELATED APPLICATIONS

This application is based upon and claims the benefit of priority from prior Japanese Patent Application No. 2009-129264, filed May 28, 2009, the entire contents of which are incorporated herein by reference.

### BACKGROUND

Recently, along with the rapid advances in performance of electronic devices, notably the speed of LSIs, is the serious problem of faulty operations caused by electromagnetic noise and signal speed limitations in electrical wires used to connect various devices using LSIs. Particularly, the above problem becomes more significant for high definition display units with high video data throughput.

In order to cope with the above problem associated with the wiring, some optical interconnection devices that transmit signals by use of light are proposed. As a representative example, an optical wiring cable that connects connectors containing active elements such as optical semiconductor devices and drive ICs by use of an optical wire such as an optical fiber is provided. Further, an optoelectronic wiring cable having an optical interconnection and electrical wires compounded for power source wiring and control communication between a light transmission side and a light reception side at the time of optical interconnection is proposed as is disclosed in JP-A 2004-179733 (KOKAI). In addition, the structure disclosed in JP-A 2006-59867 (KOKAI) is also proposed as a small optoelectronic conversion module.

### SUMMARY

According to one aspect of this invention, there is provided an optical wiring cable comprising a first connector including a light transmission portion, a second connector including a light reception portion, an optical wire provided between the first and second connectors to optically couple the light transmission portion and light reception portion, and a heat release wire provided along the optical wire and thermally coupled with one of the light transmission portion and light reception portion to release heat generated from one of the light transmission portion and light reception portion.

According to another aspect of this invention, there is provided an optical wiring cable comprising a light transmission portion having one main surface of a mounting board on which a light-emitting element and a drive IC that drives the light-emitting element are mounted, a first connector including the light transmission portion, a light reception portion having one main surface of a mounting board on which a light-receiving element and a drive IC that drives the light-receiving element are mounted, a second connector including the light reception portion, an optical wire provided between the first and second connectors to optically couple the light transmission portion and light reception portion, and a heat release wire that has one end connected to a surface opposite to the surface of the mounting board of the light transmission portion on which the drive IC is mounted, has the other end connected to a surface opposite to the surface of the mounting board of the light reception portion on which the drive IC is mounted and is thermally coupled with the respective drive ICs of the light transmission portion and light reception portion to release heat generated from the respective drive ICs.

According to another aspect of this invention, there is provided an optical wiring cable comprising a first connector including a light transmission portion, a second connector including a light reception portion, an optical wire provided between the first and second connectors to optically couple the light transmission portion and light reception portion, a power source line arranged to extend from the first connector to the second connector and used as an electric power supply line of the light transmission portion and light reception portion, and a ground line arranged to extend from the first connector to the second connector and used as an electric power supply line of the light transmission portion and light reception portion, wherein one of the power source line and ground line is thermally coupled with one of the light transmission portion and light reception portion to release heat generated from one of the light transmission portion and light reception portion.

### BRIEF DESCRIPTION OF THE DRAWING

FIG. 1 is a plan view showing the overall structure of an optical wiring cable according to a first embodiment of this invention.

FIG. 2 is a perspective view showing the structure of a transmission-side connector portion of the optical wiring cable of FIG. 1.

FIG. 3 is a top view showing the structure of a transmission-side connector portion of an optical wiring cable according to a second embodiment of this invention.

FIG. 4 is a cross-sectional view taken along the line A-A′ of FIG. 3, for illustrating the second embodiment.

FIG. 5 is a cross-sectional view taken along the line B-B′ of FIG. 3, for illustrating the second embodiment.

FIG. 6 is a cross-sectional view showing the structure of a transmission-side connector portion of an optical wiring cable according to a fifth embodiment of this invention.

FIG. 7 is a view showing the circuit configuration of an optical wiring cable according to a sixth embodiment of this invention.

### DETAILED DESCRIPTION OF THE INVENTION

Embodiments of this invention will be explained with reference to the accompanying drawings. The explanation is based on several concrete structures as examples, but the embodiments can be realized by using other materials and structures having the same functions and this invention is not limited to the following embodiments.

### First Embodiment

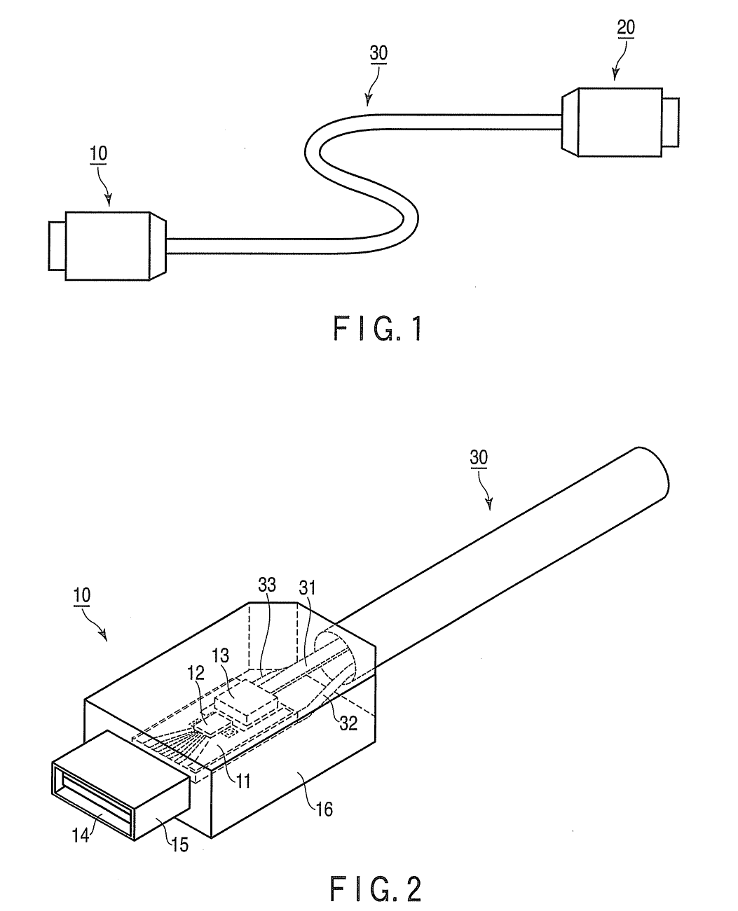

FIG. 1 is a plan view showing the overall structure of an optical wiring cable according to a first embodiment of this invention.

A transmission-side terminal connector (first connector) 10 including a light transmission portion and a reception-side terminal connector (second connector) 20 including a light reception portion are connected by means of a cable 30 including an optical wire. The connector 10 comprises a connector plug connected to an external device on the transmission side, converts an electrical signal input from the external device to a light signal and transmits the light signal to the cable 30. The connector 20 comprises a connector plug connected to an external device on the reception side, converts a light signal input from the cable 30 to an electrical signal and transmits the electrical signal to the external device.

FIG. 2 is a perspective view showing the structure of the transmission-side terminal connector 10 of the connectors 10 and 20. The reception-side terminal connector 20 has basically the same structure as the connector 10 except that the light reception portion is used instead of the light transmission portion.

In FIG. 2, 11 denotes a mounting board used to mount an active element and the like thereon, 12 a drive IC, 13 a light transmitter, 14 a connector plug, 15 a shield (that is hereinafter referred to as a plug shield) of the connector plug 14, 16 a mold (that is hereinafter referred to as a connector mold) of the connector 10, 31 an optical wire (for example, an optical fiber, optical waveguide) and 32, 33 heat release wires.

The connector plug 14 is a resin member that has internal electrodes of the connector 10 inserted and molded therein and is engaged with a receptacle (not shown) to make electrical connection. The plug shield 15 is a metal plate for protecting the internal electrodes of the connector and preventing introduction of noise. The connector mold 16 is a portion used for protection of the internal portion of the connector 10 and acts as a grasping portion at the insertion/removal time of the connector 10.

The heat release wires 32, 33 are formed of Cu, for example, transmit heat generated from the drive IC 12 to the cable 30 and radiate heat in the length direction of the cable 30 to dispersedly radiate heat away from the connector 10. It is preferable to provide the heat release wires 32, 33 to extend from the connector 10 to the connector 20. As the heat release wires 32, 33, a heat release wire extending from the connector 10 and a heat release wire extending from the connector 20 may be formed of the same wire or may be formed of different wires.

In this case, generally, the heat generated by transistors provided in the drive IC 12 needs to be released by some means, except when the power consumption is very low, such as several mW. As a normal heat release method, a method for preparing a heat sink or heat spreader near the drive IC 12 and thermally coupling the drive IC therewith to radiate heat is provided. Therefore, the volume of an active element-mounting portion will be increased.

That is, in an optical wiring cable having an active element provided in a terminal connector, the power consumption of the active element is relatively high and heat release is required. In an air-cooling system by providing a heat release member on the mounting portion of the active element, it is necessary to ensure a required heat release area around the active element-mounting portion (generally, the terminal connector of the cable). Therefore, there occurs a problem that the active element-mounting portion becomes larger in comparison with the required mounting area of the main components of the light transmission portion or light reception portion. Further, in a case where the terminal connector of the optical wiring cable is connected to an information device, the terminal connector may sometimes be heated by the heat of the information device. If this heat from the active element is not effectively released, the function of the optical wiring cable may be interrupted in an extreme case.

However, in this embodiment, heat release of the drive IC 12 is performed by means of the heat release wires 32, 33 and heat is not only released in a portion near the drive IC 12 but also dispersedly released in a portion extending to a distant portion of the heat release wires 32, 33 in the length direction. As a result, it becomes unnecessary to provide a heat sink or heat spreader near the drive IC 12.

In the embodiment with the above structure, the following effects can be attained. The first effect is to set the terminal connector portion of the optical wiring cable to have the minimum required area or volume for mounting the optical semiconductor device and drive IC by not providing a heat sink or heat spreader in the light transmission portion or light reception portion. Normally, the heat sink or heat spreader requires a large surface area. Therefore, the light transmission portion or light reception portion including the heat sink or heat spreader requires an area or volume that is several times the minimum required area or volume for mounting the optical semiconductor device and drive IC. As a result, there occurs a problem that the terminal connector portion of the optical wiring cable tends to become large. In this embodiment, the above problem can be solved by using the heat release wires 32, 33.

As the second effect, overheating of the drive IC due to a reverse heat flow can be prevented. In a case where a heat amount of a device connected to the optical wiring cable is large or the connection portion of the terminal connector is a heat release portion of the device (an exhaust portion of the air cooling device), the heat sink or heat spreader acts as a heat receiver to cause a reverse heat flow. As a result, the drive IC is heated, which makes it impossible for the optical interconnection to operate in some cases. On the other hand, in the optical wiring cable of this embodiment, since heat release is dispersedly performed in a portion ranging from the terminal connector to a position away from the terminal connector, heat will not be retained in one spot and the drive IC can be prevented from being heated by the reverse heat flow. That is, when the cable is connected to a device that generates a relatively large amount of heat, it is preferable to not only release heat of the active element (such as a drive IC or optical semiconductor device) contained in the optical wiring cable in a portion near the connector end portion but also dispersedly release heat in a portion extending to the distant portion of the cable in the extending direction thereof as in this embodiment.

Since the required thermal resistance of the heat release wire is determined according to an amount of heat to be released, i.e., the heat release resistance per unit length of the cable 30, the minimum value of the thickness of the heat release wires 32, 33 is determined based on the above value. Further, as the heat release wires 32, 33, a plurality of relatively thin wires can be used instead of thick wires by taking the flexibility thereof into consideration. Further, in a case where a shield metal for electromagnetic shielding is provided on the cable 30, the shield metal can be used as the heat release wires 32, 33. Therefore, the wire diameter and the number of heat release wires 32, 33 can be adequately determined according to the material thereof and an amount of heat generated from a to-be-heat-released object.

Thus, according to this embodiment, heat generated from the active element (such as the drive IC 12) of the optical wiring cable is released by means of the heat release wires 32, 33 contained in the cable 30. As a result, the size of the connectors 10, 20 can be reduced to a necessary and minimum mounting area of the mounting components and a small, light and low-cost optical wiring cable can be realized. That is, heat generated from the active element in the connector can be effectively released without increasing the size of the connector containing the active element. Thus, this embodiment can contribute to a reduction in size and cost of a high-definition video apparatus or the like and the effect that this embodiment can contribute to development of information communication devices can be attained.

### Second Embodiment

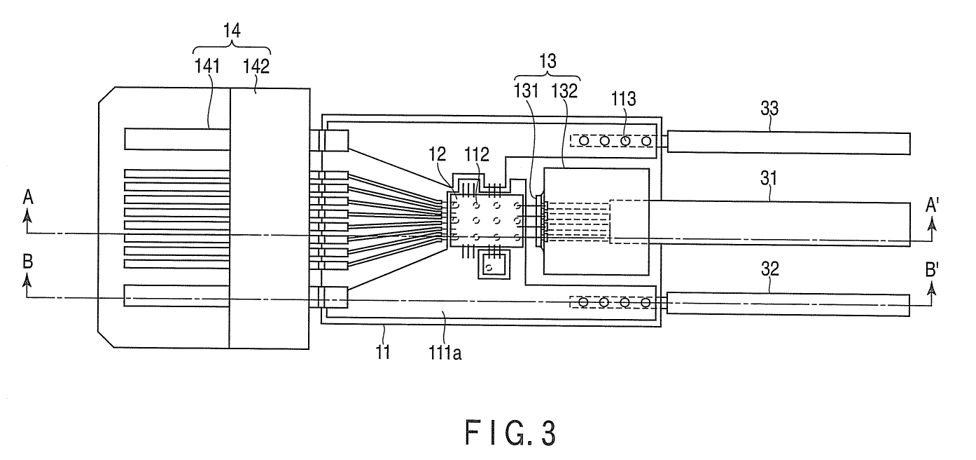

Next, an embodiment in which heat generated from a drive IC 12 is efficiently transmitted to heat release wires 32, 33 is explained with reference to FIGS. 3 to 5.

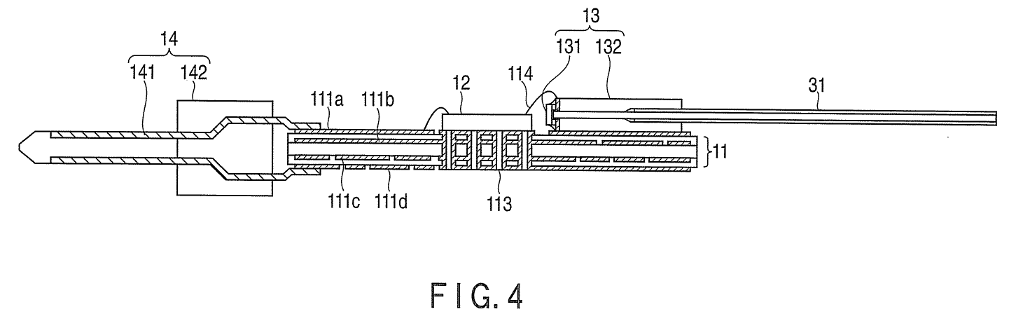

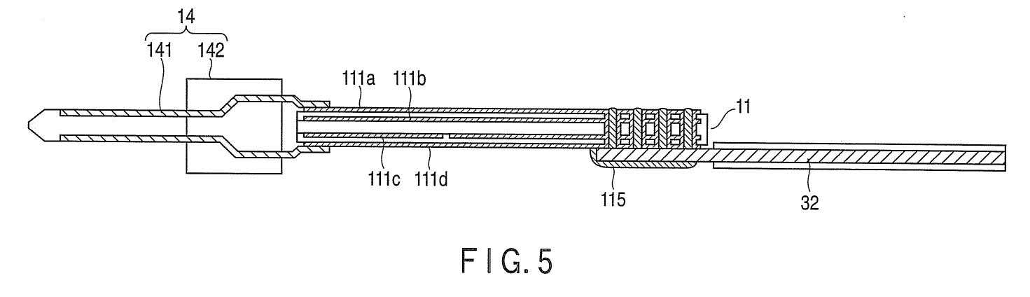

FIG. 3 is a top view schematically showing the mounting board 11 shown in FIG. 2 and a member connected thereto. FIG. 4 is a cross-sectional view taken along the line A-A′ of FIG. 3 and a wire portion (wire pitch converting portion) on the left portion of the mounting board 11 is shown by a cross-sectional view taken along the electrical wire. FIG. 5 is a cross-sectional view taken along the line B-B′ of FIG. 3. In FIGS. 3 to 5, a transmission-side terminal connector 10 is shown and a reception-side terminal connector 20 has basically the same structure as the connector 10 except that a light reception portion is used instead of a light transmission portion.

In FIGS. 3 to 5, 111 (111a to 111d) denotes electrical wire layers (patterned Cu foils) of the mounting board 11, 112 thermal vias (through holes whose inner surfaces are plated: PTH: Plated Through Holes) formed in the mounting board 11, 113 through holes for soldering (PTH) formed in the mounting board 11, 114 bonding wires, 115 a solder, 131 an optical semiconductor device (such as a light-emitting diode, semiconductor laser or light-receiving element), 132 a ferrule that fixes and holds the optical semiconductor device 131, optical fiber and the like, 141 connector plug electrodes and 142 an electrode mold.

As the mounting board 11, a board in which electrical wire layers are formed with the two-layered or four-layered structure may be used. In this example, in order to use a microstrip line as an impedance matching wire in a high-speed interconnection portion, a case wherein a four-layered board in which an insulating film with a ground layer can be easily formed thin is used is explained.

As shown in FIG. 4, a light transmitter 13 has a structure obtained by optically coupling an optical wire 31 such as an optical fiber with the optical semiconductor device 131 by means of the ferrule 132 and leading the electrode of the optical semiconductor device 131 to the side surface of the ferrule 132. As the light transmitter 13, an optoelectronic conversion module disclosed in JP-A 2006-59867 (KOKAI) can be used. Further, the optical semiconductor device 131 is a light-emitting element such as a light-emitting diode or semiconductor laser and is electrically connected to the drive IC 12 via the bonding wire 114 of Au, for example. The optical semiconductor device emits light according to a current from the drive IC 12 and transmits a light signal to the optical fiber. The drive IC 12 is a driver IC that drives the light-emitting element according to an electrical signal input from the connector plug electrode 141.

In a case where the reception-side terminal connector 20 is used in place of the transmission-side terminal connector 10, a light-receiving element such as a photodiode is used as an optical semiconductor device of the light receiver, receives a light signal from the optical fiber and supplies a light-receiving current to the drive IC. Further, the drive IC of the reception-side terminal connector 20 is configured by a receiver IC that outputs an electrical signal to the connector plug electrode according to the light-receiving current.

Heat release of the drive IC 12 is first performed towards the mounting board 11, but in this case, the method of three-dimensionally radiating heat from the bonding portion between the drive IC 12 and the mounting board 11 influences the heat release performance (reduces the thermal resistance). In a case where the heat release wires are used and the heat release wires 32, 33 are connected to the same surfaces of the drive IC 12 and mounting board 11, a heat release path is mainly formed of a surface-layered electrical wire 111a of the mounting board 11. In this case, the thermal resistance of the heat release path can be reduced only when the surface-layered electrical wire 111a is made sufficiently thick. Further, since the thickness of a high-speed wire (microstrip line) that connects the drive IC with the connector plug electrode 141 is increased if the surface-layered electrical wire 111a is made thick, the controllability of a patterning process (particularly, for a cross-sectional shape) of the surface-layered electrical wire 111a becomes a problem. In addition, since a variation in the characteristic impedance tends to be large and the facing area of the sidewalls of the microstrip lines is increased, interline cross talk tends to be a problem.

By taking the above problems into consideration, in this embodiment, the heat release wires 32, 33 are connected to the surface opposite to the surface of the mounting board 11 on which the drive IC is mounted. As a result, heat release of the drive IC 12 is performed towards the undersurface of the mounting board 11. In this case, heat can be rapidly radiated towards the undersurface side from the bonding portion between the drive IC 12 and the mounting board 11 by forming a larger number of thermal vias 112 in the mounting portion of the mounting board 11 on which the drive IC 12 is mounted. At this time, since the heat release direction is set to a direction from the surface-layered electrical wire 111a to a lower-layered wire 111d, heat release in the lateral direction can be attained by use of the surface-layered electrical wire 111a, inner-layered electrical wires 111b, 111c and lower-layered wire 111d. That is, the heat release path as viewed from the drive IC 12 spreads in three-dimensional directions in comparison with a case wherein the heat release wires 32, 33 are connected to the same surface as the mounting surface of the drive IC 12. Therefore, the effect that the thermal resistance as viewed from the drive IC 12 can be easily reduced is provided.

Thus, it becomes unnecessary to make the surface-layered electrical wire 111a extremely thick. The surface-layered electrical wire 111a is optimized to attain a high-speed wire and the heat release performance may be enhanced with respect to the inner-layered electrical wires 111b, 111c and lower-layered wire 111d. For example, the Cu film thickness of the surface-layered electrical wire 111a is set to 25 μm, which is used in a general mounting board, the Cu film thickness of the lower-layered wire 111d is set to 100 μm and a combination of the above Cu film thicknesses can be used. At this time, the thermal vias 112 are formed with diameters of, for example, 0.3 mmφ and arranged in a lattice form with a pitch of 0.6 mm in an area corresponding to the chip area of the drive IC 12. Further, the thermal vias function as heat release vias extending from the surface-layered electrical wire 111a to the lower-layered wire 111d by plating the inner surfaces thereof with 25 μm of Cu, 10 μm of Ni, 0.3 μm of Au.

With the above structure, heat generated from the drive IC 12 is effectively transmitted to the heat release wires 32, 33 by connecting the heat release wires 32, 33 to the undersurface (the surface opposite to the mounting surface of the drive IC 12) of the mounting board 11. Therefore, the effect obtained in the first embodiment can be further effectively exhibited.

### Third Embodiment

In the first and second embodiments, the heat release wires 32, 33 can also be used as electrical wires used to supply electric power and a low-speed signal in parallel to the optical wire 31. For example, electric power supplied from the light transmission side or light reception side can be supplied to the opposite side of the cable by setting 32 of FIG. 2 to a ground line and 33 of FIG. 2 to an electric power supply line.

With the above configuration, it becomes unnecessary to supply electric power from both of the light transmission side and light reception side and it becomes sufficient if electric power may be supplied from either the light transmission side or the light reception side to the optical wiring cable. As a result, optical interconnection can be attained without preparing stabilizing power sources on both of the light transmission side and light reception side, that is, preparing two power sources in the transmission line and a device connection interface can be simplified.

Further, the wires can be utilized for a relatively low-speed signal by performing the operation control of the optical interconnection (transmission link), that is, the power saving or interruption of the power source at the non-operative time, and adjustment of operation start timing in addition to the supply of electric power. For a signal that is a relatively low-speed signal but requires bidirectional transmission, it is more economical to use an electrical wire that can perform bidirectional transmission by use of a single wire rather than to use an optical interconnection that performs bidirectional transmission by providing two high-performance single-directional transmission links in opposite directions. The above electrical wires are formed of Cu wires that agree with the heat release requirement described above and can be used as heat release wires.

Thus, the heat release wires 32, 33 can also be used as electrical wires. At this time, since the electrical wires are generally formed of two or more wires (a signal line or power source line and ground line), a plurality of wires are used. Each of the wires is generally formed of an electrically independent wire and, for example, if all of the wires are soldered to the back surface of the drive IC 12 as the heat release wires 32, 33, the wires may be electrically short-circuited. Therefore, for example, heat release destinations of the light transmission side and light reception side can be set to different potential lines by using the heat release wire on the light transmission side as a ground line and using the heat release wire on the light reception side as a power source line. Of course, it is possible to use the heat release wire on the light transmission side as a power source line and use the heat release wire on the light reception side as a ground line. Further, the heat release wires on the light transmission side and light reception side may be set to the same potential (both are set to the ground line, power source line or control line) and the other wires may be insulated.

At this time, the heat release wires on the back surface of the drive IC 12 and the wires other than the heat release wires are electrically insulated and then connected, but in general, thermal resistances thereof will be increased when the wires are electrically insulated. Therefore, it is preferable to use the wire (for example, ground line) with the least thermal resistance as a heat release wire directly connected to the back surface of the drive IC 12 and twist the other wires with the heat release wire to form a twisted line. In this case, the wires are electrically isolated by the coatings of the wires, but they are twisted with the heat release wires in portions for a relatively long distance in comparison with the wire diameter in the extending direction of the cable. Therefore, thermal coupling occurs between the heat release wires and the other wires that are twisted therewith and may contribute to thermal conduction and heat release.

### Fourth Embodiment

A solder can be used to connect the heat release wires 32, 33 with the mounting board 11 as described before. At this time, as shown in FIG. 4, the thermal resistance for heat release can be reduced by providing soldering through holes (PTH) 113 of a relatively large diameter in the connecting portions of the heat release wires 32, 33. For example, as the soldering through holes 113, through holes of a diameter of 1 mmφ with a pitch of 2 mm are provided in the connection pad area of the heat release wires 32, 33 and the inner surfaces thereof are plated with Cu of 25 μm, Ni of 10 μm, Au of 0.3 μm. At this time, the heat release wires 32, 33 are solder-connected and a solder is filled in the soldering through holes 113 by the capillary phenomenon and, as a result, all the through holes are formed of metal.

Thus, not only is the heat transmitted through a lower-layered wire 111d, but also the heat transmitted through a surface-layered electrical wire 111a and inner-layered electrical wires 111b, 111c is efficiently transmitted to the heat release wires 32, 33 via the through holes 113. That is, the thermal resistance of the heat release path that extends from the drive IC 12 to the heat release wires 32, 33 will be reduced. The processing for the mounting board 11 does not require any additional steps and has an effect that the thermal resistance can be reduced without causing any additional rise in cost.

### Fifth Embodiment

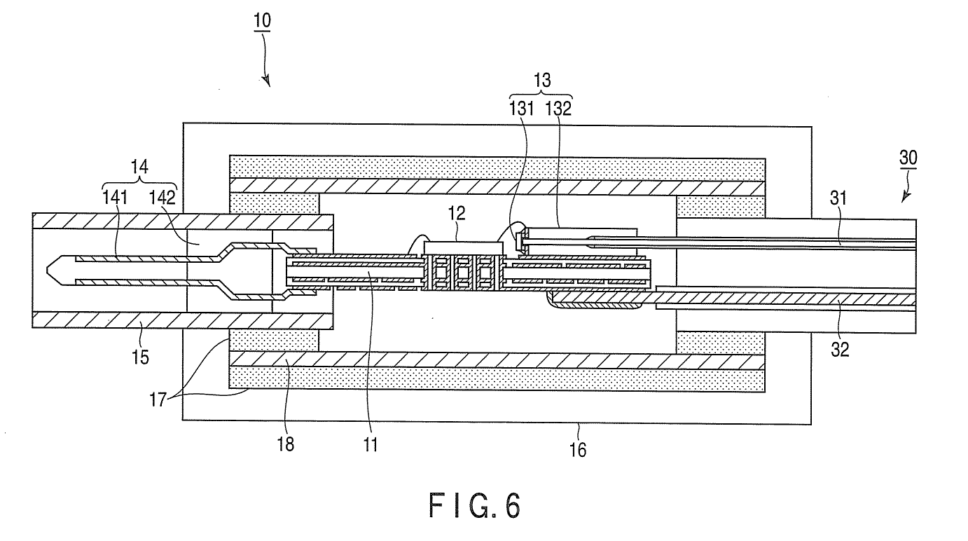

Next, an embodiment that more effectively exhibits the advantages of this invention is explained with reference to FIG. 6. In FIG. 6, 17 denotes a thermal insulator and 18 denotes a connector shield.

A connector plug 14 is formed by insert-molding a connector plug electrode 141 (for example, Ni-plated brass (brass), copper-alloyed lead such as phosphor bronze) with resin material 142 such as a liquid crystal polymer by using a metal mold. A portion other than the connector plug electrode 141 has a relatively high thermal insulating property. However, since a plug shield 15 (for example, a bending-processed product of a metal plate obtained by Ni-plating and tin-plating brass or copper-alloyed lead such as phosphor bronze) has a thermal conduction property, heat on the exterior of the connector (particularly, a device to be connected) can be easily transmitted to the interior of the connector.

This indicates the possibility that heat generated from the to-be-connected device is transmitted to the internal portion of the terminal connector to prevent heat release of the drive IC 12 and obstruction of the operation. Further, in a case where cooling air exhausted from the to-be-connected device is blown to the connector although a heat sink or heat spreader is not provided in the terminal connector portion, heat on the exterior of the connector is transmitted to the interior via the connector mold 16 (for example, thermoplastic elastomer or fluoro rubber) of FIG. 1. In this case, the same problem will occur.

Therefore, in the case of FIG. 6, the plug shield 15 is divided at the end of the connector plug portion and the connector shield 18 is provided with the thermal insulator 17 disposed therebetween so as to be thermally isolated therefrom. Further, a thermal insulator 17 is provided outside the connector shield 18 and a connector mold 16 (for example, thermoplastic elastomer or fluoro rubber) is provided to surround the thermal insulator. For example, the connector shield 18 may be formed of a bending-processed copper-alloy plate that is subjected to Ni-plating and tin-plating, like the plug shield 15, to ensure the strength of the terminal connector and prevent noise from being input and output. As the thermal insulator 17, for example, a glass fiber sheet or plastic foam sheet may be used.

With the above structure, heat from the exterior of the terminal connector 10 is shielded to prevent the drive IC 12 and optical semiconductor device 131 from being heated and becoming inoperative. Generally, the operation of surrounding a heat-generating element with a thermal insulator causes various problems due to heat generated by the heat-generating element. However, in a case where heat is released in a portion extending away from the heat-generating element by use of the heat release wires 32, 33 as in this embodiment, introduction of extra heat is prevented by surrounding the heat-generating element with an thermal insulator, and it becomes possible to perform a stable operation even in an environment in which a thermal load from the exterior is large.

As described above, according to this embodiment, in addition to the effects of the first to fourth embodiments, thermal interference from the external connection device can be suppressed by thermally insulating the terminal connector 10 and it becomes possible to further reduce the size, weight and cost.

### Sixth Embodiment

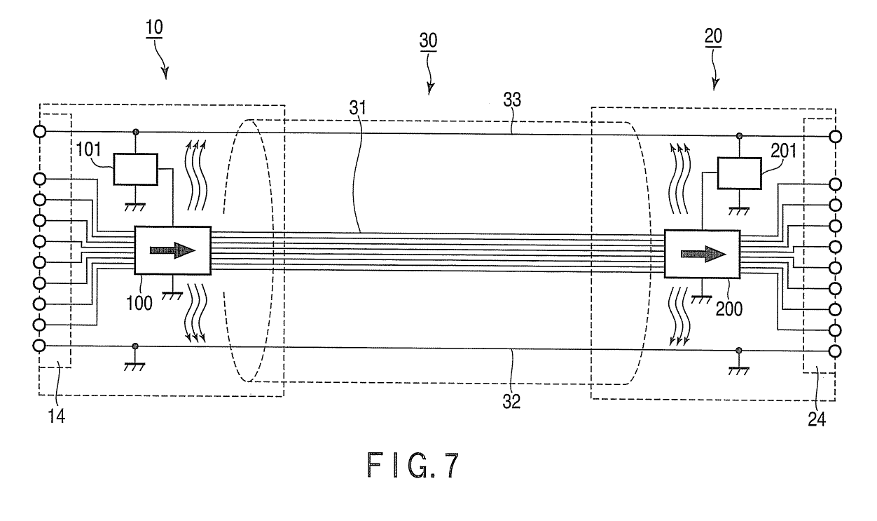

Next, an embodiment for solving a problem peculiar to this invention that tends to occur when the electric power supply lines are used as the heat release wires 32, 33 is explained with reference to FIG. 7.

In FIG. 7, 10 denotes a transmission-side terminal connector (first connector), 14 a connector plug, 20 a reception-side terminal connector (second connector), 24 a connector plug, 30 an optical wire, 100 a light transmission portion, 200 a light reception portion, and 101, 201 stabilizing power source or DC-DC converter. Further, the electric power supply wires 32 (ground line), 33 (power source line) are formed to extend from one terminal connector 10 to the other terminal connector 20 as shown in FIG. 7. Thus, electric power can be supplied to both of the light transmission portion 100 and light reception portion 200.

In this case, if the operation voltage of the light transmission portion 100 and light reception portion 200 is 3.3 V, for example, a power source voltage supplied to the power source line 33 is set higher than the above voltage; for example, it is set to 5 V. Then, voltages supplied to the light transmission portion 100 and light reception portion 200 are dropped to 3.3 V via the DC-DC converters (or stabilizing power sources) 101, 201 and then supplied thereto. Further, a power source voltage (5 V) is supplied from one of the light transmission portion 100 and light reception portion 200 and, in this example, it is supposed that the power source voltage is supplied only from the light transmission portion 100.

At this time, for example, if the resistances of the power source wire and ground wire are 5 ohms and a current consumed on the reception side is 120 mA, a voltage (V(33)−V(32)) in the light reception portion 200 becomes 3.8 V. However, as the power source voltage is supplied to the light reception portion 200 via the DC-DC converter (or stabilizing power source) 201, the voltage of 3.3 V is stably acquired and supplied.

In a case where the power source voltage is supplied while the DC-DC converter (or stabilizing power source) 201 is not provided, the power source voltage in the light transmission portion 100 and the power source voltage in the light reception portion 200 are different. Therefore, it becomes necessary to relatively increase the power source voltage variation resistance of the drive ICs contained in the light transmission portion 100 and light reception portion 200. In the example described before, a relatively large power source voltage variation resistance of ±0.6 V (approximately ±20%) with respect to 3.3 V becomes necessary and it is generally difficult to perform the operation. It is assumed that the drive IC permits the power source voltage variation of ±20% and the operation is started with the power source voltage in the light transmission portion 100 set at 3.9 V and the power source voltage in the light reception portion 200 set at 2.7 V. Even in this case, if the wires 32, 33 are designed to have the function of the heat release wires that are the main feature of this invention, the resistance rises due to heat release to the power source line and ground line during the operation and the power source voltage in the light reception portion 200 will exceed −20%. Therefore, it becomes difficult to maintain the operation.

On the other hand, with the structure shown in FIG. 7, even if the temperatures of the ground line 32 and power source line 33 rise and the wire resistances are increased, the voltage in the light reception portion 200 is stabilized by the DC-DC converter (or stabilizing power source) 201. A stable operation can be performed as long as the input voltage is higher than or equal to the output voltage of 3.3 V.

Thus, according to this embodiment, the stabilizing power sources, i.e., DC-DC converters 101, 201 are connected between the power source line 33 and the light transmission portion 100 and light reception portion 200. Therefore, a problem that the application voltages of the drive ICs on the transmission side and reception side are made different due to the influence of a voltage drop by the presence of the power source wire and ground wire can be solved and an advantage that it becomes unnecessary to increase the power source voltage variation resistance of the drive ICs can be attained. Further, since heat of the drive IC can be released by means of the ground wire 32 and power source wire 33, the same effect as that of the first embodiment can be obtained.

### Modification

This invention is not limited to the above embodiments. For example, some concrete examples are shown in the above embodiments of this invention described above, but they are only examples of the configurations, and other means (circuits, structures, device configurations or the like) may be used instead of the respective elements according to the spirit of this invention. Further, the configurations shown in the embodiments are only examples and this invention can be embodied by combining the above embodiments.

In the above embodiments, only the light transmission portion is contained in the first connector and only the light reception portion is contained in the second connector. However, a light transmission portion and light reception portion may be contained in each connector to perform a bidirectional transmission operation. Further, it is not always necessary to thermally couple the heat release wires with both of the light transmission portion and light reception portion, and the heat release wire may be coupled with one of the light transmission portion and light reception portion.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical wiring cable comprising:
a first connector including a light transmission portion,
a second connector including a light reception portion,
an optical wire provided between the first and second connectors to optically couple the light transmission portion and light reception portion, and
a heat release wire provided along the optical wire and thermally coupled with one of the light transmission portion and light reception portion to release heat generated from one of the light transmission portion and light reception portion.

2. The cable of claim 1, wherein each of the light transmission portion and light reception portion comprises an optical semiconductor device that is optically coupled with the optical wire to perform a converting operation between a light signal and electrical signal, a drive IC that drives the optical semiconductor device, and a mounting board having one main surface on which the drive IC is mounted, and the heat release wire has one end connected to a surface opposite to the surface of the mounting board of the light transmission portion on which the drive IC is mounted, has the other end connected to a surface opposite to the surface of the mounting board of the light reception portion on which the drive IC is mounted and is thermally coupled with the respective drive ICs to release heat generated from the drive ICs.

3. The cable of claim 2, wherein a connection of the heat release wire to the mounting board is attained by a soldered joint and a through hole that extends from a front surface of the mounting board to a back surface thereof and whose inner surface is metal-plated is formed in a portion of the mounting board to which the heat release wire is connected, the through hole being filled with a solder.

4. The cable of claim 1, wherein a plurality of electrical wires are provided between the first and second connectors and at least one of the electrical wires is the heat release wire.

5. The cable of claim 4, wherein the electrical wire used as the heat release wire and the other electrical wires are twisted to form a twisted wire.

6. The cable of claim 1, wherein the first and second connectors respectively include casings, and thermal insulators are respectively provided between the casing of the first connector and the light transmission portion and between the casing of the second connector and the light reception portion.

7. The cable of claim 1, wherein each of the first and second connectors comprises a connector plug connected to an external device, a plug shield that shields the connector plug, and a connector shield that shields the casing of the connector and further includes a thermal insulator between the plug shield and the connector shield.

8. The cable of claim 1, wherein the heat release wire includes a first heat release wire and a second heat release wire different from the first heat release wire, the first heat release wire is thermally coupled with the light transmission portion to release heat generated from the light transmission portion, and the second heat release wire is thermally coupled with the light reception portion to release heat generated from the light reception portion.

9. An optical wiring cable comprising:
a light transmission portion having one main surface of a mounting board on which a light-emitting element and a drive IC that drives the light-emitting element are mounted,
a first connector including the light transmission portion,
a light reception portion having one main surface of a mounting board on which a light-receiving element and a drive IC that drives the light-receiving element are mounted,
a second connector including the light reception portion,
an optical wire provided between the first and second connectors to optically couple the light transmission portion and light reception portion, and
a heat release wire that has one end connected to a surface opposite to the surface of the mounting board of the light transmission portion on which the drive IC is mounted, has the other end connected to a surface opposite to the surface of the mounting board of the light reception portion on which the drive IC is mounted and is thermally coupled with the respective drive ICs of the light transmission portion and light reception portion to release heat generated from the respective drive ICs.

10. The cable of claim 9, wherein a connection of the heat release wire to the mounting board is attained by a soldered joint, and a through hole that extends from a front surface of the mounting board to a back surface thereof and whose inner surface is metal-plated is formed in a portion of the mounting board to which the heat release wire is connected, the through hole being filled with a solder.

11. The cable of claim 9, wherein a plurality of electrical wires are provided between the first and second connectors and at least one of the electrical wires is the heat release wire.

12. The cable of claim 11, wherein the electrical wire used as the heat release wire and the other electrical wires are twisted to form a twisted wire.

13. The cable of claim 9, wherein the first and second connectors respectively include casings, and thermal insulators are respectively provided between the casing of the first connector and the light transmission portion and between the casing of the second connector and the light reception portion.

14. The cable of claim 9, wherein each of the first and second connectors comprises a connector plug connected to an external device, a plug shield that shields the connector plug, and a connector shield that shields the casing of the connector and further includes a thermal insulator between the plug shield and the connector shield.

15. An optical wiring cable comprising:
a first connector including a light transmission portion,
a second connector including a light reception portion,
an optical wire provided between the first and second connectors to optically couple the light transmission portion and light reception portion,
a power source line arranged to extend from the first connector to the second connector and used as an electric power supply line of the light transmission portion and light reception portion, and
a ground line arranged to extend from the first connector to the second connector and used as an electric power supply line of the light transmission portion and light reception portion,
wherein one of the power source line and ground line is thermally coupled with one of the light transmission portion and light reception portion to release heat generated from one of the light transmission portion and light reception portion.

16. The cable of claim 15, further comprising one of a stabilizing power source circuit and DC-DC converter provided between the power source line and the light transmission portion and light reception portion.

17. The cable of claim 15, wherein each of the light transmission portion and light reception portion comprises an optical semiconductor device optically coupled with the optical wire to perform a converting operation between a light signal and an electrical signal, a drive IC that drives the optical semiconductor device, and a mounting board having one main surface on which the drive IC is mounted, one end of either the power source line or the ground line is connected to a surface opposite to the surface of the mounting board of the light transmission portion on which the drive IC is mounted, one end of a remaining one of the power source line and the ground line is connected to a surface opposite to the surface of the mounting board of the light reception portion on which the drive IC is mounted, and the power source line and the ground line are thermally coupled with the respective drive ICs to release heat generated from the drive ICs.

18. The cable of claim 15, wherein a connection of one of the power source line and ground line to the mounting board is attained by a soldered joint, and a through hole that extends from a front surface of the mounting board to a back surface thereof and whose inner surface is metal-plated is formed in a portion of the mounting board to which one of the power source line and ground line is connected, the through hole being filled with a solder.

19. The cable of claim 15, wherein the first and second connectors respectively include casings, and thermal insulators are respectively provided between the casing of the first connector and the light transmission portion and between the casing of the second connector and the light reception portion.

20. The cable of claim 15, wherein each of the first and second connectors comprises a connector plug connected to an external device, a plug shield that shields the connector plug, and a connector shield that shields the casing of the connector and further includes a thermal insulator between the plug shield and the connector shield.
